(19) United States
(12) Patent Application Publication
(10) Pub. No.: US 2018/0268439 A1
(43) Pub. Date: Sep. 20, 2018

(54) DYNAMICALLY GENERATING AND DELIVERING SEQUENCES OF PERSONALIZED MULTIMEDIA CONTENT

(71) Applicant: International Business Machines Corporation, Armonk, NY (US)

(72) Inventors: Priscilla B. Avegliano, Sao Paulo (BR); Alecio P.D. Binotto, Sao Paulo (BR); Carlos H. Cardonha, Sao Paulo (BR); Rodrigo Laiola Guimaraes, Vitoria (BR); Lucas C. Real Villa, Sao Paulo (BR)

(21) Appl. No.: 15/460,566

(22) Filed: Mar. 16, 2017

(51) Int. Cl. G06Q 30/02; G06K 9/00; G06F 3/147

(52) U.S. Cl. CPC G06Q 30/0261; G06K 9/00302; G06Q 30/0269; G06K 9/00369; G06F 3/147; G06K 9/00255

(57) ABSTRACT

Dynamically generating and delivering multimedia presentations targeted to an individual and to a group of users at public rendering devices such as displays in a point in time based on customers' static and dynamic context. Customers' emotional state(s) are assessed while and/or after watching personalized multimedia presentations and used to dynamically change presentations and to drive the allocation of resources for other services within the premise.

### FIELD

The present application relates generally to computers and computer applications, and more particularly to generating of multimedia content.

### BACKGROUND

The rise of online and mobile experience is changing business models for traditional enterprises such as financial services firms. Nevertheless, there is little evidence that the emergence of new electronic channels for delivering enterprise services has substantially diminished the need for traditional premises such as branch offices. For instance, according to a recent report from the Federal Deposit Insurance Corporation (FDIC), there has only been a slight fall in bank branches. In addition, although mobile and online channels may be recent, new electronic channels for delivering banking services, such as the ATM, have been introduced by banks for decades. Yet, the total number of banking offices between 1970 and 2014 grew nearly twice as fast as the general population. This may not be surprising in enterprises such as banking, as the branch remains in one aspect at the heart of everything that a bank is and where banking relationships are built.

Rather than directly switching from branch banking to online and mobile services, customers are increasingly attracted to a multi-channel approach, using a mixture of online and offline services. In this scenario, branches still remain the first point of call for purchasing financial services products. Customers may value face-to-face interaction and buying products in branches rather than online or over the phone remains popular across product ranges.

Additionally, customers may be demanding solutions to satisfy their unique needs. For example, in financial enterprises, customers may be increasingly showing interest for expert financial advice so that they can easily understand the benefits and risks of investments. Therefore, the positive experience at on-premise (e.g., branch office) can play a major role in building trust and improving customer loyalty.

### BRIEF SUMMARY

A system and method of dynamically generating and delivering sequences of personalized multimedia content may be provided. The system, in one aspect, may include at least one hardware processor. A display device may be coupled to the at least one hardware process. A storage device may be coupled to the at least one hardware processor and store a database comprising at least user profile. The at least one hardware processor may detect a user entering an area via at least one motion sensor. The at least one hardware processor may capture via at least one camera, images of the user entering the area. The at least one hardware processor may identify the user based on analyzing the images of the user. The at least one hardware processor may retrieve from the database, a user profile associated with the user based on the identifying. The at least one hardware processor may track the user's location within the area via the at least one motion sensor. The at least one hardware processor may continuously capture facial expression images of the user via the at least one camera. The at least one hardware processor may continuously detect the user's emotional state based on the facial expression images. The at least one hardware processor may identify at least one display device available at the user's location. The at least one hardware processor may generate a sequence of multimedia content based on the user's emotional state and the user profile. The at least one hardware processor may display the sequence of multimedia content on the display device. Based on continuously detecting the user's emotional state, the at least one hardware processor may determine the user's current emotional state responsive to the displaying of the sequence of multimedia content. The at least one hardware processor may determine whether the user's current emotional state exceeds a threshold emotional state indicator, Responsive to determining that the user's current emotional state exceeds the threshold emotional state indicator, the at least one hardware processor may send a signal comprising a notification to trigger a service.

A method of dynamically generating and delivering sequences of personalized multimedia content, in one aspect, may include detecting a user entering an area via at least one motion sensor. The method may also include capturing via at least one camera images of the user entering the area. The method may further include identifying the user based on analyzing the images of the user. The method may also include retrieving from a database user profile associated with the user based on the identifying. The method may further include tracking the user's location within the area via the at least one motion sensor. The method may also include continuously capturing facial expression images of the user via the at least one camera. The method may further include continuously detecting the user's emotional state based on the facial expression images. The method may also include identifying at least one display device available at the user's location. The method may further include generating a sequence of multimedia content based on the user's emotional state and the user profile. The method may also include displaying the sequence of multimedia content on the display device. The method may further include, based on continuously detecting the user's emotional state, determining the user's current emotional state responsive to the displaying of the sequence of multimedia content. The method may also include determining whether the user's current emotional state exceeds a threshold emotional state indicator. The method may further include, responsive to determining that the user's current emotional state exceeds the threshold emotional state indicator, sending a signal comprising a notification to trigger a service.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIGS. 1A and 1B show a diagram illustrating a method of the present disclosure in one embodiment.

FIG. 2A shows a data structure storing customer's profile data in one embodiment of the present disclosure.

FIG. 2B shows a data structure storing customer's emotion level in one embodiment of the present disclosure.

FIG. 2C shows a data structure storing demand for profiles in one embodiment of the present disclosure.

FIG. 3 shows a data structure storing media metadata and ranking based on demand for profile in one embodiment of the present disclosure.

FIG. 4 is a diagram showing generating of a multimedia content from a media repository in one embodiment of the present disclosure.

FIG. 5 is a diagram illustrating components of a system in one embodiment of the present disclosure.

FIG. 6 illustrates a schematic of an example computer or processing system that may implement a personalized multimedia content generation system in one embodiment of the present disclosure.

### DETAILED DESCRIPTION

A system and method may be provide that leverage a number of automated services (e.g., face identification and recognition to identify and track customers, wearable devices and smart clothes to capture users' emotional state) to dynamically generate and exhibit in public displays targeted multimedia presentations (e.g., financial advertisements, news summaries) taking into account not only the presence of customers in a given location at a point in time, but also their associated emotional state. The change in customers' emotional state while and/or after watching such personalized multimedia presentations as well as the engagement with this content may also be taken into account to gear the change and allocation of resources for other services within the location or environment such as a bank (e.g., queue or line management, coffee service, other service). The method and system may boost the customer experience at a location, e.g., in a banking center or branch, and more generally, in brick-and-mortar environments.

The system and method may provide for the maximization of customers' experience by dynamically generating and delivering in public displays multimedia presentations targeted to an individual, and/or to a group of users in a given location (e.g., bank branch) in a point in time. The system and method in one embodiment takes into account the retailer's strategy (e.g., bank promotion to sell products), dynamicity of the environment (e.g., people coming and going) as well as users' attention, engagement, emotional and well being data (e.g., stress level, openness) captured from a number of devices such as surveillance cameras (ambient intelligence), Internet of Things (IoT) devices (for example, wearable devices, smart clothes, sensors embedded in home appliances like instrumented fridge, microwave), apps or applications that users interact with retailers, banks, through RFID, sensors, historic user data, user demographics and preferences. The system and method also consider that the analysis or estimation of the impact of such content in customers' emotional and well being state, and the engagement of the customer with the dynamic content being presented, may be used to further improve and gear the management of other services and resources (e.g., reorganization of waiting queue or line, beverage service or the like, another service) within a location.

The system in one embodiment may create and/or store a database containing image of faces of multiple customers. The database may incrementally augmented over time with additional data (e.g., additional images of existing and/or additional customers), which may lead to better face identification and recognition results. The system may communicate with multiple data sources to receive or obtain input to identify, recognize and/or track people coming and going at the location, and to compute users' attention, emotional, and well being data (e.g., from cameras, wearable devices, smart clothes, home appliances, social media, interaction with apps), users' preferences, and historic data (e.g., used to build and assess user profile). A set of multimedia materials (e.g., video snippets, banners, news summaries) designed for multiple profiles (e.g., conservative, high-risk investor) and target groups (e.g., earnings between defined ranges) may be received and stored. In one aspect, multimedia content can also incorporate traits and user preferences for target groups (e.g., information preference added by the customer in his/her online profile) to include offers or discounts for the target individual or group, for example, tickets to a concert or art exhibition. External data supports the identification of the customer's current mood (e.g., recent social media data) and the estimation of changes on mood based on historic data (e.g., perceived mood variations motivated by media content of different types).

When a customer is identified and recognized in the premises of the financial center (e.g., in the elevator or in the waiting room through computer vision or IoT sensors), companies like banks, retailers, others, are able to dynamically and optimally generate and display personalized multimedia (e.g., subliminal) advertisements, news summaries, services, new products (and any content compilation) targeted to the group of consumers currently in that location. Users' response to these changes in the public displays placed in the environment (e.g., measured based on the assessment of emotional and well-being data as well as engagement with the dynamic content being presented) are then used to better manage other services and resources (e.g., waiting queue or line, beverage service).

In one embodiment of the present disclosure, a customer or the like entering an area (e.g., a financial center, another brick-and-mortar store, another area) may be detected. For instance, sensors such as motion sensor, camera or another device may detect the customer.

The image of the customer (e.g., facial image) is captured, for example, from a camera or footage from a surveillance system or like, and compared with a database of facial images, and the customer is automatically identified and recognized based on the comparison. Additionally, the customer's mood, emotional, and well-being state is detected or estimated, for example, using image recognition and sentiment analysis of content recently posted in social networks (e.g., the customer's online posting on social network or media or another online channel in the past defined period of time (e.g., past 1 hour) may be examined to determine the customer's sentiment).

The customer's location within the area may be tracked, e.g., the customer's premises of the financial center may be tracked. Motion sensors and/or cameras in a surveillance system may detect the particular location of the customer.

A sequence of multimedia content (e.g., video showing that an offer with the best interest rate) is automatically computed and displayed on one or more display screens in the area. Using a financial center as an example, the sequence of multimedia content may be generated by taking into account the bank's financial strategy and interest of a customer. In one aspect, the interest of others in the area, for example, group interests and preferences of other customers in a given space may be considered. For example, as additional customers enter the area, the steps 202, 204 and 206 may be performed for each of those customers. So for example, if there is more than one customer in the area, the multimedia content may be generated based on all of the customers' interests and preferences.

For example, for each product offered by the financial center such as a bank, the system of the present disclosure computes the sum of the expected financial returns from the clients given the presentation of an advertisement for that product; the expected financial return of each client may be given by the product of the probability with which the client will purchase that product after seeing an advertisement multiplied by the amount of money the individual will invest. After computing these values for each product, the system sorts them in descending order and picks the top k products, where k is a value that can be defined by the bank and/or system administrator.

Such multimedia content (e.g., advertisements, news summaries), which can be targeted at several customers at the same time, are composed dynamically also considering the dynamics of customers moving between spaces. The system in one embodiment may track the customer moving to and from different rooms or locations of the area via one or more cameras installed in the area. The visual images that are captured by the camera(s) are analyzed to extract or determine the customer's emotional data by visual computing. In one embodiment, each customer data triggers a type of content and a summarization of all content is displayed to all individuals in the area.

Based on the (implicit or explicit) feedback of particular customer or customers (e.g., they are looking at the screen, emotional and well being data gathered from sensors), the method may include considering different approaches, such as narrowing down or focusing advertisement or new summaries to a particular individual or sub-group. Implicit feedback can be obtained through, for example, intelligent cameras placed next to televisions, which detect customers who display boredom or indifference to the content that is played, as determined by facial expression analysis (e.g., delineating the mouth and detecting whether it is a smiley face in the shape of an arc or not, or detecting still eyes). As another example, implicit feedback can be obtained by physical sensors such as those available on smart watches which measure and broadcast heart rate and arm motion. Sudden increases on heart beat may be an indicator that the individual is excited about the multimedia contents played back by the bank, for instance. Such information may be obtained via communicating (via a computer or communication network) with a server that detects and logs data associated with the physical sensors. Explicit feedback can be provided through “Like” and “Unlike” icons to denote approval or disapproval of the content, for example, on a social website page (e.g., shown on the individual's or user's cell phone or on the display screen (displaying the content), e.g., through a touch screen interface).

The system and/or method may include computing and sharing the effect of such multimedia intervention in the emotional and well being state (e.g., stress, patience, openness, mood level, engagement) of individuals and of the crowd so that other services and resources (e.g., reordering of waiting queue, coffee service) within the area (e.g., financial center or bank) can be better managed. If a content is displayed (or for example, a service is provided such as serving beverage or a product is offered) and the system captures that after this action the individual emotional state or satisfaction is changed, then such information or data may be stored in a database so that in future similar interventions the same procedure may be performed with those individuals or individuals having the characteristics of those individuals. A customer's satisfaction may be measured based on camera captured images and visual recognition in those images. If the system detects that the customer is unsatisfied, a new product can be offered and the system can track whether the customer's mood changed.

The area described above need not be limited to a financial center or bank, but may include any area where an individual enters and includes one or more display devices, and a camera with a motion sensor that detects and captures an image of the individual in the area. Other examples of an area may include but not limited to a restaurant and other brick-and-mortar stores. In this way, for example, the individual's or customer's experience in the area may improve positively, e.g., enhancing building of customer's trust and loyalty to the financial center, restaurant and/or others.

A system in one embodiment of the present disclosure automatically recognizes customers located in a given space. The system is able to detect emotional state of the customers and also has knowledge about preferences, retailer strategy and customers' past behavior. The system automatically generates an optimized sequence of multimedia content targeted to the group based on a strategy of an enterprise associated with the given space (e.g., bank's strategy) and collective interests and preferences of the customers in the given space and the customers' emotional data. The system monitors customers' engagement towards exhibited multimedia content (e.g., who is looking at the screen, emotional and well being data gathered from sensors) and can dynamically recalculate the multimedia content to display next, for example, narrowing the content down to focus on a preference of a particular individual or sub-group. The system computes and shares the effect of such multimedia intervention in the emotional and well being state (e.g., stress, patience, openness, mood level, engagement) of individuals and of the crowd so that other services and resources (e.g., reordering of waiting queue, coffee service) within the given space (e.g., bank) can be better managed.

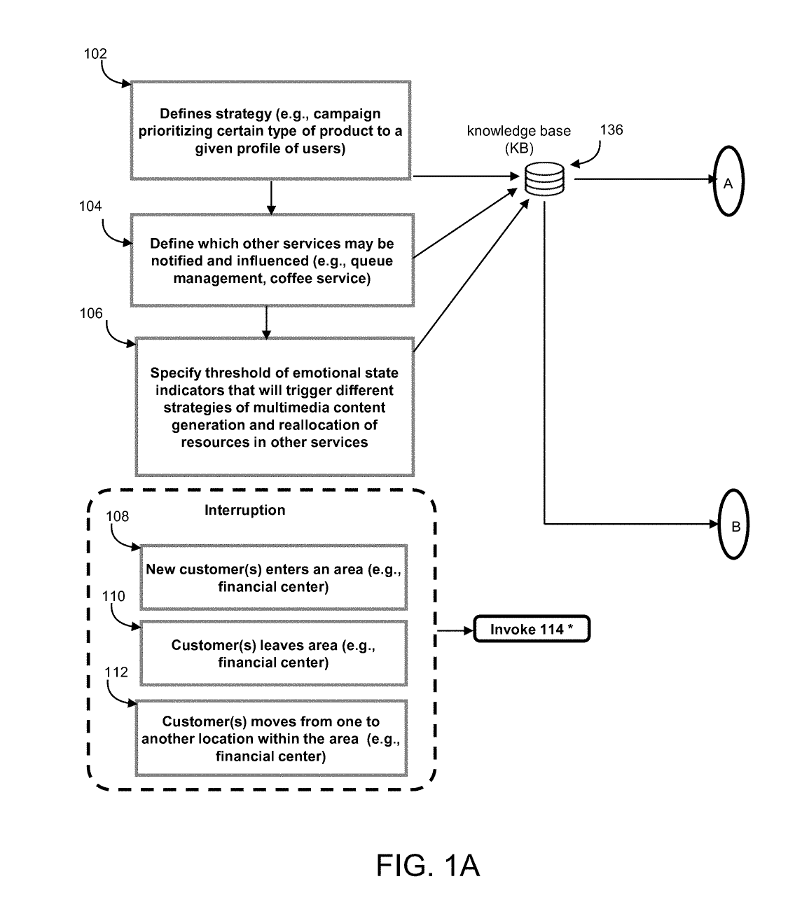

FIGS. 1A and 1B show a diagram illustrating a method of the present disclosure in one embodiment. The method may be performed by one or more hardware processors, for example, coupled to a storage device. One or more hardware processors may connect to a communication network, for example, for communicating with other devices and/or processors. At 102, an enterprise (e.g., bank or another financial institution, a retailer or another brick-and-mortar store, or like) may define its strategy (e.g., prioritizing a type of product to a given profile of users. The strategy may be stored in a knowledgebase in a storage device 136.

At 104, the enterprise defines which other services may be notified and influenced (e.g., queue management, coffee or beverage service, or another service that improves a customer's experience in an area of the enterprise). A list of services to be notified (referred to as notification services) may be stored in a knowledge base in a storage device 136.

At 106, the enterprise also defines or specifies a threshold of emotional state indicators that will trigger different strategies of multimedia content generation and reallocation of resources in one or more other services, for example, notification services. The threshold may be defined per individual. The threshold may be interpreted as a threshold value for anxiety level of an individual. It can be determined that once the threshold value is exceeded, the user experience is affected.

The system and/or method of the present disclosure in one embodiment detect signals caused by one or more of interruptions shown at 108, 110 and 112, and automatically triggers an execution of a function shown starting at 114. For example, at 108, a new customer (or user) entering an area or premise of the enterprise (e.g., a financial center) may be detected. At 110, a customer leaving the area may be detected. At 112, a customer moving from one location in the area to another location in the area may be detected. A motion sensor and camera installed in the area may detect a customer or individual entering the area, exiting the area and/or moving around within the area and a camera, for example, may capture images of the detected customer. Responsive to detecting the interruption (e.g., customer entering, existing, moving), the function shown at 114 is automatically triggered or executed.

At 114, image recognition or face recognition software or like module may be executed to automatically identify and recognize the customer or individual detected at one or more of 108, 110, and 112. For instance, capture image or images of the customer may be compared with stored images (e.g., at 136) to identify the customer.

At 116, the system and/or method may continuously track the customer in the premises of the area (e.g., the financial center). For example, the system may analyze via visual computing images captured by one or more cameras to determine the customer's emotional data. This information can also be extracted from sensors carried by the customers (e.g., localization beacons, global position system (GPS) device).

At 118, the system and/or method may automatically detect and continuously monitor the customer's emotional state. The customer's emotional state may be monitored by activity sensors (e.g., on wearable devices of the customer) that capture physiological signals. Additionally, image recognition techniques can also be applied to infer emotional state of a customer by processing the images captured by the cameras.

At 120, the system and/or method may identify public rendering devices available at the customer's current location. For example, a location or locations in the area where one or more devices are installed may be identified by accessing a specification that defines where such devices are in the area. For example, a financial center or bank may have a list with the Internet Protocol (IP) addresses and geo-location of displays it owns to where multimedia contents can be broadcasted. Examples of such devices may include a television or computer with display screens. Whether a public rendering device is located or installed within a defined distance of the customer's current location may be determined to identify one or more available devices.

At 122, the system and/or method may automatically compute optimized sequence of multimedia content to display, for example, to a customer or a group of customers in the location.

At 124, the system and/or method may render the optimized sequence of multimedia content generated at 122, in public devices available in given location, for example, on the devices determined at 120.

At 126, the system and/or method may monitor customer's or customers' engagement toward the exhibited multimedia content. For instance, the customer's position, direction of the customer's gaze, facial expression while viewing the multimedia content may be captured in an image or series of images and analyzed. At 126, the system and/or method may monitor customer's or customers' engagement toward the exhibited multimedia content. For instance, once the system detects the customer's position (e.g., his head), the direction of the customer's gaze and facial expression while viewing the multimedia content may be captured in an image or series of images and analyzed. Such analysis may, for example, be conducted by delineating and identifying the shape of mouth, eyes, eyebrows, and the position of head against the shoulders. By doing such facial expression characterization the customer's emotional state may be determined.

If there is more than one customer in the location, the emotional states of each of those customers may be evaluated and determined. A cumulative emotional level indicator of the customers at the location may be determined based on the emotional states of the customers at the location. The system may infer the cumulative emotional level via sentiment analysis on social media; for example, the system may collect recent posts from the user and employ sentiment analysis algorithms in order to infer the mood and/or anxiety level of the individual. Video recognition solutions may also support this operation (e.g., determine whether the individual is smiling or is showing anxiety). The system infers an emotional level per individual and defines the emotional level as an emotional level indicator. Each individual also has an associated emotion threshold level. The emotional level indicator exceeding the emotion threshold level indicates that the individual is not satisfied. An emotional level of an individual is also referred to as the cumulative emotional level for that individual. If only one customer is detected at the location of the multimedia content rendering, the cumulative emotional level indicator is the emotional level indicator of that customer.

At 128, the cumulative emotional state is compared to a threshold emotional state indicator, for example, defined and stored in knowledge base 136, and it is determined as to whether the cumulative emotional level indicator exceeds the threshold emotional state indicator.

If it is determined that the cumulative emotional level indicator does not exceed the threshold, at 130, the system and/or method may register in the knowledge base 136 that the strategy of rendering or displaying at the public display device is working. The logic proceeds to 126 to continue to monitor the customer's or customers' engagement with the exhibited multimedia content.

If it is determined that the cumulative emotional level indicator exceeds the threshold, at 132, the system and/or method may register in the knowledge base 136 that the strategy of rendering the generated multimedia content is not working, and proceeds to 134.

At 134, the system and/or method may recomputed or generate another optimized sequence of multimedia content, for example, by returning to 124. For example, for each product offered by the financial center such as a bank, the system of the present disclosure computes the sum of the expected financial returns from the clients given the presentation of an advertisement for that product; the expected financial return of each client may be given by the product of the probability with which the client will purchase that product after seeing an advertisement multiplied by the amount of money the individual will invest. After computing these values for each product, the system sorts them in descending order and picks the top k products, where k is some a value that can be defined by the bank and/or system administrator. Notification is sent to the services. The notification may trigger other services offered by that branch (e.g., free coffee service, concierge, and/or other service).

In one aspect, at 114, the system and/or method of the present disclosure in one embodiment may consider finishing the presentation of the current sequence (or at least part of it, e.g., the current video) to avoid disruption before rendering a new sequence of multimedia content on a display device.

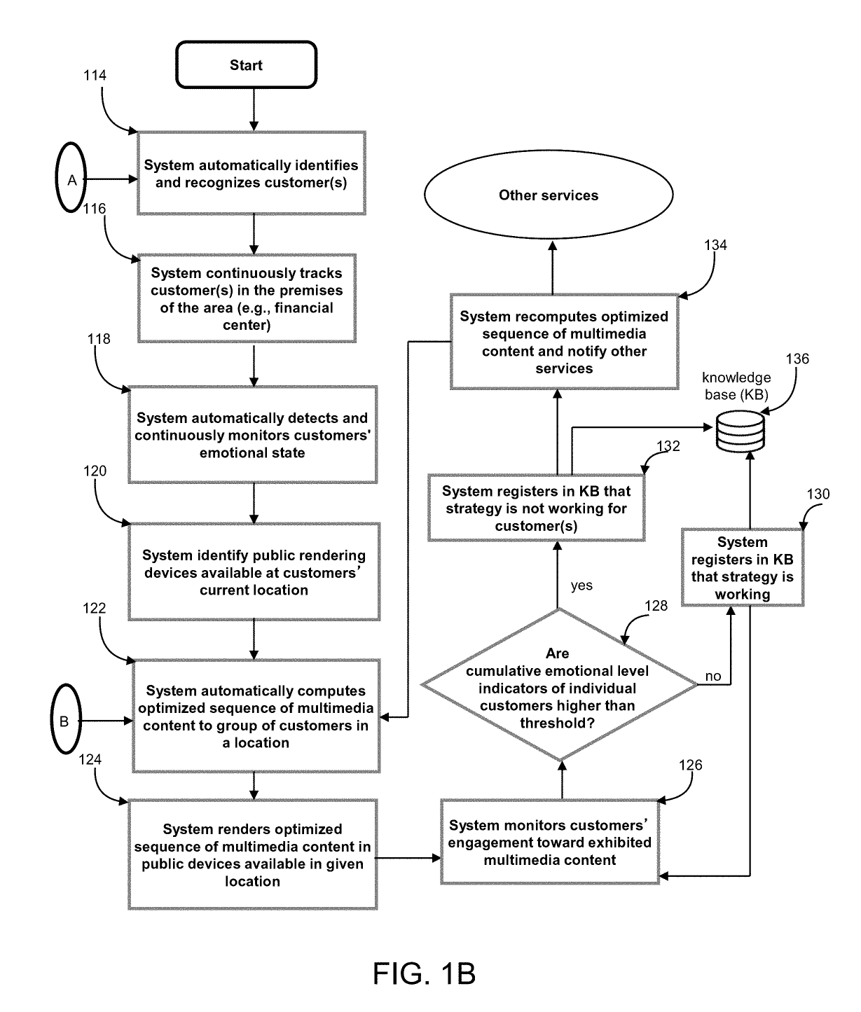

FIG. 2A shows a data structure storing customer's profile data in one embodiment of the present disclosure. The data structure may include a two dimensional table with rows and columns. Each row may represent a user and the columns represent attributes or profiles of the user. For example, the profile of a customer is composed of different interests, traits, preferences. In this example, these aspects are illustrated by each customer having different amounts of profiles X, Y and Z.

FIG. 2B shows a data structure storing customer's emotion level in one embodiment of the present disclosure. An emotion level of a user may be determined based on a plurality of different emotion indications (e.g., different dimension of emotions), for example, stress, patience, mood. A customer's (user's) emotion level may be determined as a sum of the different emotion indicators. The values assigned to each dimension of emotion belong to pre-defined ranges. For example, if Stress is 0.9, the user is very stressed; if Patience=0.9, the user is very calm. This type of information can also be extracted from physiological sensors, image processing, and social networks. E_u is a weighted sum of the different dimensions of emotion. For example, E_u can be given by E_u=3*Stress−Patience−Mood. For example, customers' aggregated emotional level (E_u) may be composed of a number of indicators, each of which, may have weights as illustrated (e.g., stress weight=3, patience weight=−1 and mood weight=−1).

FIG. 2C shows a data structure storing demand for profiles in one embodiment of the present disclosure. Each customer has several profiles that match the customer's set of interests. For each profile (Pu), there is a weight. Each customer also has a current emotional state (Eᵤ). In one embodiment, the demand for a given profile (dₚ) is the sum of all customers' emotional state multiplied by that customer's weight for that profile:

$${d}_{p} = {\sum }_{u} {\sum }_{p} {Profile}_{p , u} \cdot {E}_{u} .$$

This demand (dₚ) is then used to determine the multimedia content to be displayed. For instance, multimedia contents associated with demands of higher value may be played first. For example, the demand for a given profile (dₚ) is computed based on users that are at a given location in a certain point in time (in the example, users 1, 2 and 3 share the same space).

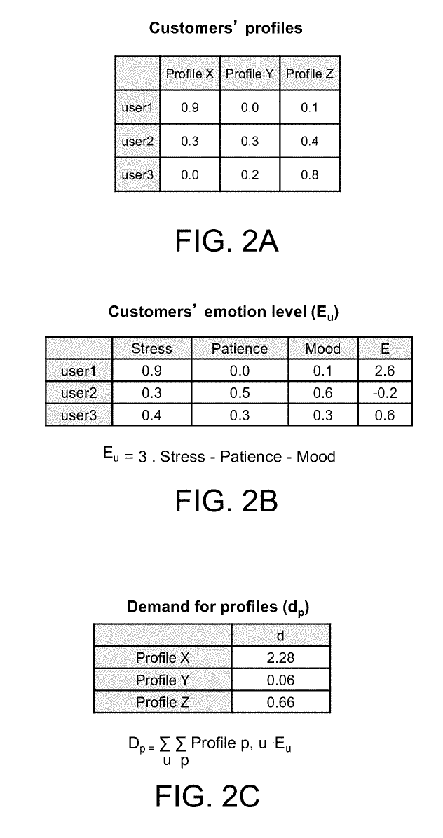

FIG. 3 shows a data structure storing media metadata and ranking based on demand for profile (Rᵥ) in one embodiment of the present disclosure. FIG. 3 represents a ranking of content to be displayed based on the Demand calculation shown in FIG. 2C. In one embodiment, the multimedia content is played in the order of the Rank, from highest to lowest. The rank shows which content is the most suitable one for that configuration of people and current associated emotional state, e.g., determined according to:

$${R}_{v} = {\sum }_{p} {d}_{p} \cdot {Profile}_{p , v} .$$

The notation v represents multimedia, e.g., video.

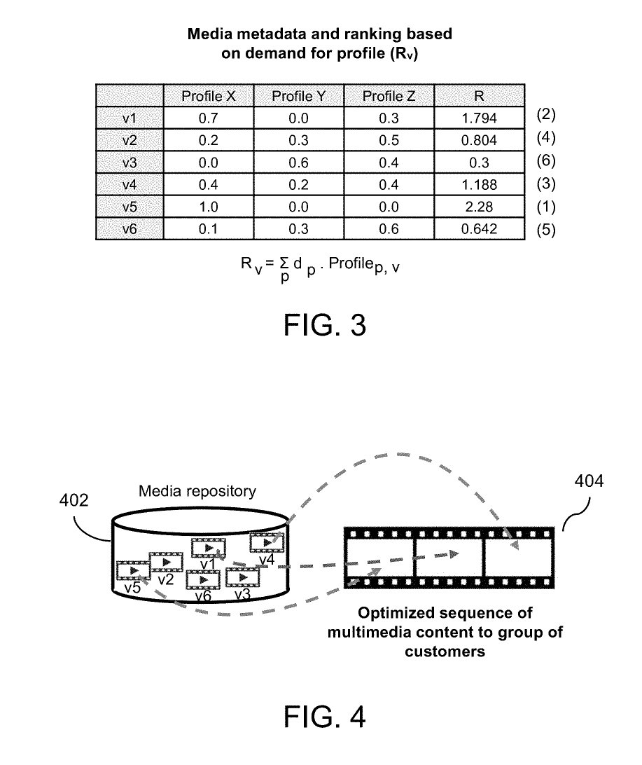

FIG. 4 is a diagram showing generating of a multimedia content from a media repository in one embodiment of the present disclosure. A media repository 402 may include a plurality of media data. An optimized sequence of multimedia 404 may be generated based on a ranking for example generated as shown in FIG. 3. For example, the system may generate the optimized sequence of multimedia content by computing the ranking of each media content (Rᵥ) based on the demand for different profiles (dₚ) and selecting the first ‘k’ media elements with highest rank (in the example, k=3 and the media selected are v5, v1 and v4).

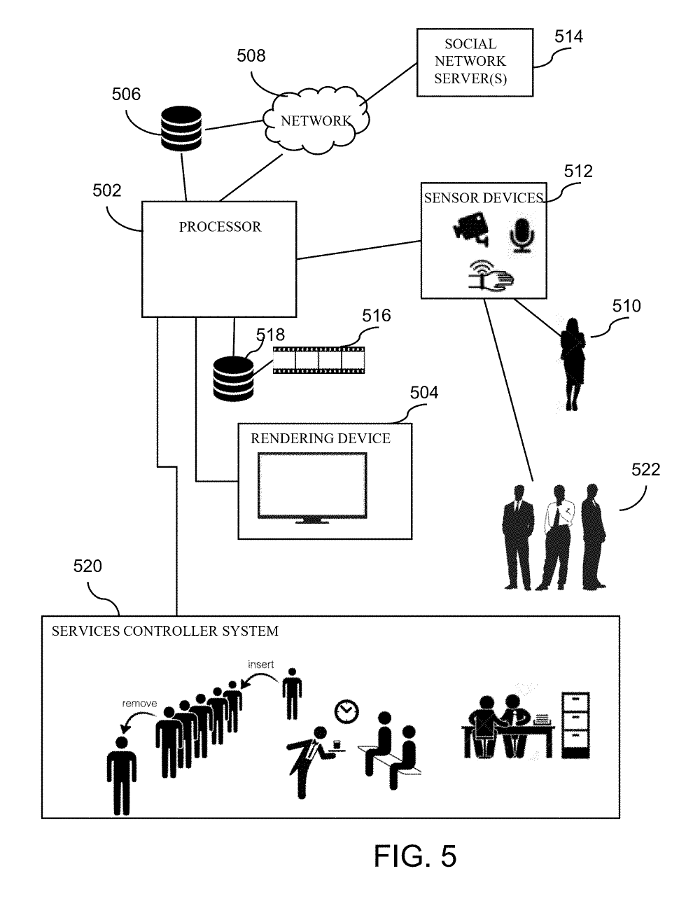

FIG. 5 is a diagram illustrating components of a system in one embodiment of the present disclosure. The system in one embodiment creates and delivers dynamically sequences of personalized multimedia. The system may include at least one hardware processor 502 and a rendering device 504 such as a display device coupled to the hardware process. A storage device 506 may be coupled to a hardware processor 502 and store a database including at least user profile data. The storage device 506, for example, may be connected to the hardware processor 502 directly or via a network 508 (e.g., computer network, communication network). The hardware processor 502 may detect a user 510 entering an area via a sensor device 512 such as a motion sensor. Sensor devices 512 may also include Internet of Things (IoT) sensors and/or devices. The hardware processor 502 may capture an image or images of the user 510 entering the area via a sensor device 512, for example, a camera. A camera may be part of a surveillance or security system. The hardware processor 502 identifies the user 510 based on analyzing the images of the user. For instance, image recognition system may analyze and compare the image of a user with known or previously stored images to recognize or identify the user 510. The hardware processor may retrieve from the database 506, a user profile associated with the user 510 based on the identifying. The hardware processor 502 may track the user's location within the area via a sensor device 512, for example, a motion sensor in the premise. The hardware processor 502 may continuously capture facial expression images of the user 510 via a sensor device 512, for example, a camera. The hardware processor 502 may continuously detect the user's emotional state based on the facial expression images. The user's emotional state may be also determined based on information extracted from a social media server 514. The hardware processor 502 may identify a rendering device 504 such as a display device available at the user's location, for example, within a threshold distance of the user's current location. The hardware processor 502 may generate a sequence of multimedia content 516 based on the user's emotional state and the user profile. The multimedia content 516, for example, may be generated from available multimedia stored in a database of multimedia data 518. In another aspect, the multimedia content 516 or a portion of the multimedia content 516 may be generated based on real-time information or data. The hardware processor 502 may display the sequence of multimedia content 516 on the rendering device 504, for example, a display device. Based on continuously detecting the user's emotional state, the hardware processor 502 may determine the user's current emotional state responsive to the displaying of the sequence of multimedia content. The hardware processor 502 may determine whether the user's current emotional state exceeds a threshold emotional state indicator. Responsive to determining that the user's current emotional state exceeds the threshold emotional state indicator, the hardware processor 502 may send a signal including a notification to trigger a service 520. In one aspect, the signal may trigger a service 520.

The hardware processor 502 may detect one or more other users 522 within a threshold distance of the display device. Responsive to detecting other user or users 522, the hardware processor 502 may determine emotional state of that user (or users) 522 and may generate the sequence of multimedia content based on the user's emotional state and the user profile, and the emotional state of that user (or users) 522 and associated profile. In one aspect, a variation or variations in one or more users' stress level measurement may dynamically change the compilation of personalized multimedia content.

The system in aspect maximizes customers' experience in a brick-and-mortar premise by dynamically generating and delivering multimedia presentations targeted to an individual and to a group of users at public displays in a point in time based on customers' static and dynamic context. Assessment of customers' emotional state(s) while and/or after watching such personalized multimedia presentations may be used to dynamically change presentations and to drive the allocation of resources for other services within the premise. The system in one embodiment considers a retailer's strategy (e.g., bank promotion to sell products), dynamicity of the environment (e.g., people coming and going), users' emotional data (dynamic context), attention, stress, patience, openness, mood and engagement levels captured from a number of devices and sensors, and assessment of the impact of such multimedia content in customers' emotional and well being state, and the engagement of the customer with the dynamic content being presented. The system may take into account the emotional state (e.g., stress level) of each individual in the group when dynamically compiling a playlist of multimedia content and changes in such emotional state may be considered to dynamically adapt other service such as queue management.

In one aspect, a method and system of the present disclosure may leverage on a number of automated services (e.g., face identification and recognition to identify customers, wearable devices and smart clothes to capture users' emotional state) to dynamically generate and exhibit in public displays targeted multimedia presentations (e.g., financial advertisements, news summaries) taking into account the presence of customers in a given location at a point in time, and also their associated emotional state. The change in customers' emotional state while and/or after watching such personalized multimedia presentations and the engagement with this content may also be taken into account to gear the change and allocation of resources for other services within a premise such as a bank (e.g., queue or line management, beverage/coffee/tea service to the extent that they are socially acceptable), for example, providing personalization of customer experience and boosting the customer experience in a in brick-and-mortar environments.

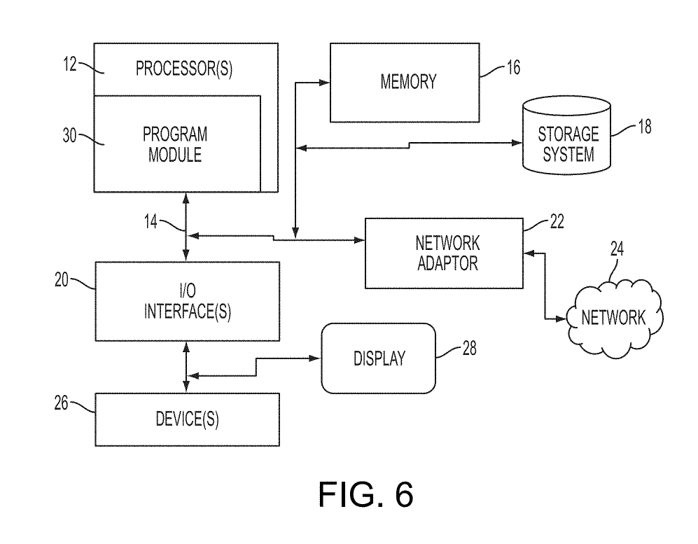

FIG. 6 illustrates a schematic of an example computer or processing system that may implement a personalized multimedia content generation system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 6 may include, but are not limited to, user computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a module 30 that performs the methods described herein. The module 30 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1.-7. (canceled)

8. A computer readable storage device storing a program of instructions executable by a machine to perform a method of dynamically generating and delivering sequences of personalized multimedia content, the method comprising:
detecting a user entering an area via at least one motion sensor;
capturing via at least one camera images of the user entering the area;
identifying the user based on analyzing the images of the user;
retrieving from a database user profile associated with the user based on the identifying;
tracking the user's location within the area via the at least one motion sensor;
continuously capturing facial expression images of the user via the at least one camera;
continuously detecting the user's emotional state based on the facial expression images;
identifying at least one display device available at the user's location;
generating a sequence of multimedia content based on the user's emotional state and the user profile;
displaying the sequence of multimedia content on the display device;
based on continuously detecting the user's emotional state, determining the user's current emotional state responsive to the displaying of the sequence of multimedia content;
determining whether the user's current emotional state exceeds a threshold emotional state indicator; and
responsive to determining that the user's current emotional state exceeds the threshold emotional state indicator, sending a signal comprising a notification to trigger a service.

9. The computer readable storage device of claim 9, further comprising:
responsive to determining that the user's current emotional state does not exceed the threshold emotional state indicator, repeating the steps of:
based on continuously detecting the user's emotional state, determining the user's current emotional state responsive to the displaying of the sequence of multimedia content; and
determining whether the user's current emotional state exceeds a threshold emotional state indicator.

10. The computer readable storage device of claim 9, further comprising:
responsive to determining that the user's current emotional state exceeds the threshold emotional state indicator, storing in a knowledgebase that the user is not responsive to the sequence of multimedia content.

11. The computer readable storage device of claim 9, further comprising:
responsive to determining that the user's current emotional state does not exceed the threshold emotional state indicator, storing in a knowledgebase that the user is responsive to the sequence of multimedia content.

12. The computer readable storage device of claim 9, further comprising:
detecting at least one other user within a threshold distance of the display device;
responsive to detecting said at least one other user, determining emotional state of said at least one other user; and
wherein the step of generating a sequence of multimedia content based on the user's emotional state and the user profile, comprises generating a sequence of multimedia content based on the user's emotional state and the user profile, and the emotional state of said at least one other user and said at least one other user's profile.

13. The computer readable storage device of claim 9, wherein the notification triggers a new queue to open.

14. A system of dynamically generating and delivering sequences of personalized multimedia content, comprising:
at least one hardware processor;
a display device coupled to the at least one hardware process;
a storage device coupled to the at least one hardware processor and storing a database comprising at least user profile;
the at least one hardware processor detecting a user entering an area via at least one motion sensor;
the at least one hardware processor capturing via at least one camera, images of the user entering the area;
the at least one hardware processor identifying the user based on analyzing the images of the user;
the at least one hardware processor retrieving from the database, a user profile associated with the user based on the identifying;
the at least one hardware processor tracking the user's location within the area via the at least one motion sensor;
the at least one hardware processor continuously capturing facial expression images of the user via the at least one camera;
the at least one hardware processor continuously detecting the user's emotional state based on the facial expression images;
the at least one hardware processor identifying at least one display device available at the user's location;
the at least one hardware processor generating a sequence of multimedia content based on the user's emotional state and the user profile;
the at least one hardware processor displaying the sequence of multimedia content on the display device;
based on continuously detecting the user's emotional state, the at least one hardware processor determining the user's current emotional state responsive to the displaying of the sequence of multimedia content;
the at least one hardware processor determining whether the user's current emotional state exceeds a threshold emotional state indicator; and
responsive to determining that the user's current emotional state exceeds the threshold emotional state indicator, the at least one hardware processor sending a signal comprising a notification to trigger a service.

15. The system of claim 14, further comprising:
responsive to determining that the user's current emotional state does not exceed the threshold emotional state indicator, the at least one hardware processor repeating:
based on continuously detecting the user's emotional state, the at least one hardware processor determining the user's current emotional state responsive to the displaying of the sequence of multimedia content; and
the at least one hardware processor determining whether the user's current emotional state exceeds a threshold emotional state indicator.

16. The system of claim 14, further comprising:
responsive to determining that the user's current emotional state exceeds the threshold emotional state indicator, the at least one hardware processor storing in a knowledgebase that the user is not responsive to the sequence of multimedia content.

17. The system of claim 14, further comprising:
responsive to determining that the user's current emotional state does not exceed the threshold emotional state indicator, the at least one hardware processor storing in a knowledgebase that the user is responsive to the sequence of multimedia content.

18. The system of claim 14, further comprising:
the at least one hardware processor detecting at least one other user within a threshold distance of the display device;
responsive to detecting said at least one other user, the at least one hardware processor determining emotional state of said at least one other user; and
wherein the at least one hardware processor generating a sequence of multimedia content based on the user's emotional state and the user profile, comprises the at least one hardware processor generating a sequence of multimedia content based on the user's emotional state and the user profile, and the emotional state of said at least one other user and said at least one other user's profile.

19. The system of claim 14, wherein the notification triggers a new queue to open.
